(19) United States
(12) Patent Application Publication
(10) Pub. No.: US 2013/0094685 A1
(43) Pub. Date: Apr. 18, 2013

(54) Micro Speaker Module

(71) Applicant: Bujeon Co., Ltd., Ansan-si (KR)

(72) Inventors: Dong Hyun Seo, Ansan-si (KR); Ji Woong Hong, Ansan-si (KR)

(73) Assignee: BUJEON CO., LTD., Ansan-si (KR)

(21) Appl. No.: 13/650,760

(22) Filed: Oct. 12, 2012

(30) Foreign Application Priority Data
Oct. 12, 2011 (KR) 10-2011-0104132

(51) Int. Cl. H04R 1/02

(52) U.S. Cl. 381/332

(57) ABSTRACT

Disclosed is a micro speaker module capable of reducing the thickness of an enclosure that supports a micro speaker. The enclosure of the disclosed micro speaker module includes a first frame having a supporting portion configured to support the micro speaker, and a second frame configured to cover an open side of the first frame. A first cover and a second cover are respectively insert injection molded with or attached to portions of the first frame and the second frame corresponding to the micro speaker that is supported by the supporting portion, which results in a reduction in the thickness of each frame.

### CROSS-REFERENCE TO RELATED APPLICATIONS

This application claims priority under 35 U.S.C. §119 to Korean Patent Application No. 10-2011-0104132, filed on Oct. 12, 2011, in the Korean Intellectual Property Office, the disclosure of which is incorporated herein by reference in its entirety.

### BACKGROUND OF THE INVENTION

1. Field of the Invention

The present invention relates to a micro speaker module, and more particularly to a micro speaker module capable of reducing the thickness of an enclosure that supports a micro speaker.

2. Description of the Related Art

In general, a portable electronic appliance, such as a portable mobile communication terminal, a laptop computer, or an MP3 player, is equipped with a micro speaker module that converts an electric signal into a sound signal.

A conventional micro speaker module includes a micro speaker, and an enclosure that supports the micro speaker and blocks rearward sound emitted from the micro speaker so as to prevent the rearward sound from mixing with forward sound.

The enclosure consists of a first frame and a second frame. The micro speaker is supported by the first frame and the first frame has a sound discharge duct for discharge of forward sound from the micro speaker. The second frame is configured to cover an open side of the first frame. A back volume space for blocking rearward sound emitted from the micro speaker is defined between the first frame and the second frame. The reason why providing the back volume space is that a low sound range may be disadvantageously offset and reduced so long as the rearward sound is not blocked, and thus sound is centered on a high sound range, which makes it difficult to reproduce natural sound.

A recent trend is to pursue a slimmer and smaller portable electronic appliance. Accordingly, a micro speaker that is intended to be mounted in a small electronic appliance case also tends to be slimmer and smaller.

However, the above described conventional micro speaker module has a limit to reduction in thickness because the first and second frames of the enclosure are formed by injection molding of synthetic resins, and therefore each frame has a required thickness. In particular, one surface of the first frame must have a predetermined thickness required to form a sound discharge hole, and therefore there is a limit to reduction in the thickness of the micro speaker module.

Moreover, the first frame of the enclosure included in the conventional micro speaker module is provided with a holding protrusion on which the micro speaker is seated and supported as described above. The holding protrusion, however, problematically causes reduced sound volume due to increased friction upon discharge of sound from the micro speaker.

Even in the case of the micro speaker included in the conventional micro speaker module, due to a gasket that is provided at the micro speaker to assist the micro speaker in coming into close contact with the first frame when supported by the holding protrusion of the first frame, there is a limit to reduction in the thickness of the micro speaker module.

### SUMMARY OF THE INVENTION

Therefore, the present invention has been made in view of the above problems, and it is one object of the present invention to provide a micro speaker module capable of achieving a reduced thickness according to a trend to pursue a smaller and slimmer portable electronic appliance.

It is another object of the present invention to provide a micro speaker module capable of preventing a micro speaker supporting structure from causing a reduction in the volume of sound emitted from a micro speaker.

In accordance with the present invention, the above and other objects can be accomplished by the provision of a micro speaker module including a micro speaker and an enclosure configured to support the micro speaker, wherein the enclosure includes a first frame having a supporting portion configured to support the micro speaker, and a second frame configured to cover an open side of the first frame by which the micro Speaker is supported, and wherein a first cover and a second cover are respectively insert injection molded with or attached to portions of the first frame and the second frame corresponding to the micro speaker that is supported by the supporting portion.

First and second through-holes may be respectively formed in surfaces of the first and second frames corresponding to front and rear surfaces of the micro speaker that is supported by the supporting portion, and the first and second covers may be insert injection molded or attached to cover at least the first and second through-holes respectively.

The first and second covers may be formed of any one of a stainless steel material, a film member material, and a PORON material.

The first frame may include a sound discharge duct, through which forward sound emitted from the micro speaker that is supported by the supporting portion is discharged outward, and the sound discharge duct may include a first sound discharge duct defined in front of the micro speaker that is supported by the supporting portion, and a second sound discharge duct in communication with the first sound discharge duct to guide the forward sound emitted from the micro speaker to one side surface of the first frame.

The supporting portion, which is provided at the first frame to support the micro speaker, may include at least one of a supporting rib configured to support an outer edge of the micro speaker and a supporting recess into which a supporting protrusion formed at a corner region of the micro speaker is inserted.

A back volume space may be defined between the first frame and the second frame, and may block rearward sound emitted from the micro speaker that is supported by the supporting portion, so as to prevent the rearward sound from mixing with the forward sound, and the back volume space may be located at a lateral side of a space in which the micro speaker is installed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a micro speaker module according to an exemplary embodiment of the present invention;

FIG. 2 is a sectional view illustrating a micro speaker illustrated in FIG. 1;

FIG. 3 is an exploded perspective view of the micro speaker module illustrated in FIG. 1;

FIG. 4 is a partial enlarged view of FIG. 3; and

FIG. 5 is a sectional view illustrating a coupled state of the micro speaker module illustrated in FIG. 1.

### DETAILED DESCRIPTION OF THE INVENTION

Hereinafter, a micro speaker module according to the exemplary embodiment of the present invention will be described in more detail with reference to the accompanying drawings.

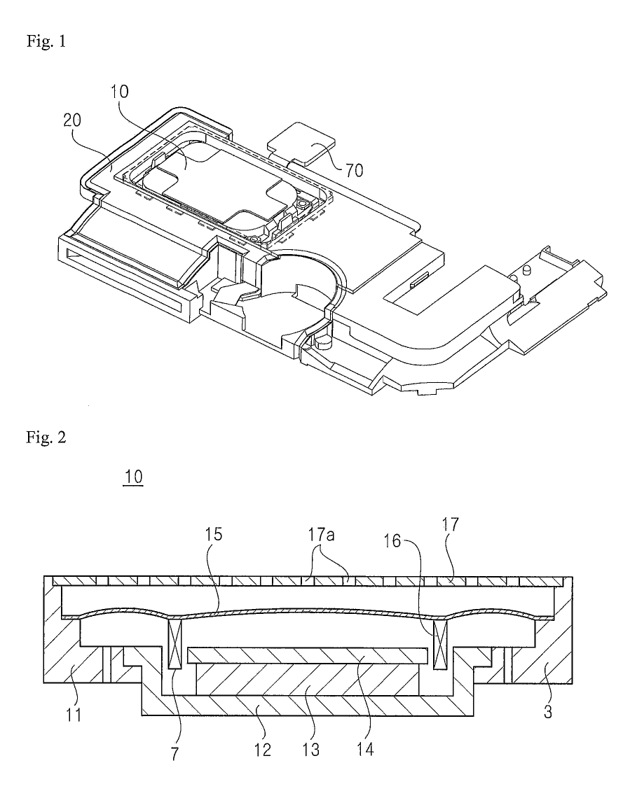

Referring to FIG. 1, the micro speaker module of the present invention includes a micro speaker 10, and an enclosure 20 by which the micro speaker 10 is supported. Reference numeral 70 denotes a terminal connected to the micro speaker 10.

The micro speaker 10, as illustrated in FIG. 2, includes a lower case 11 and an upper cover 17, which are formed by injection molding of synthetic resins, for example. Other constituent elements of the micro speaker 10 include a yoke member 12, a magnet 13, a plate 14, a vibrating plate 15, and a voice coil 16 secured to a lower surface of the vibrating plate 15, which are seated over the lower case 11 in sequence and are protected by the upper cover 17. A plurality of sound discharge holes 17a is perforated in the upper cover 17 to enable efficient discharge of forward sound generated from the vibrating plate 15.

In this case, the lower case 11 is provided with a structure, which serves not only to assist the micro speaker in being stably supported by a first frame 30 of the enclosure 20 that will be described hereinafter, but also to prevent the volume of sound emitted from the micro speaker 10 from being reduced by a supporting structure of the first frame 30. A detailed description of this structure will follow.

Considering operation of the micro speaker 10 having the above described configuration, if an electric signal is applied to the voice coil 16 to create electromagnetic force around the voice coil 16, the vibrating plate 15 vibrates along with the voice coil 16 through attraction and repulsion between the electromagnetic force of the voice coil 16 and magnetic force created by the yoke member 12, the magnet 13 and the plate 14, thereby generating a sound signal corresponding to the electric signal.

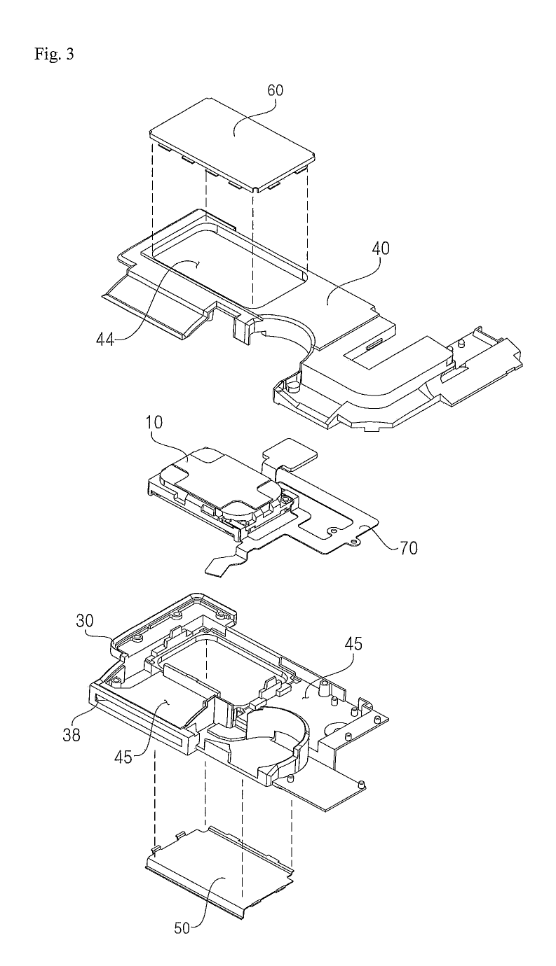

Referring to FIGS. 3 to 5, the enclosure 20 is constituted of the first frame 30 by which the micro speaker 10 is supported, and a second frame 40 configured to cover an open side of the first frame 30 in a state in which the micro speaker 10 is supported by the first frame 10.

More specifically, the first frame 30 has a supporting portion 31 to support the micro speaker 10 as described above. The supporting portion 31 is configured to eliminate the previously described problem of the related art in which a structure of supporting the micro speaker 10 disadvantageously causes a reduction in the volume of sound emitted from the micro speaker 10.

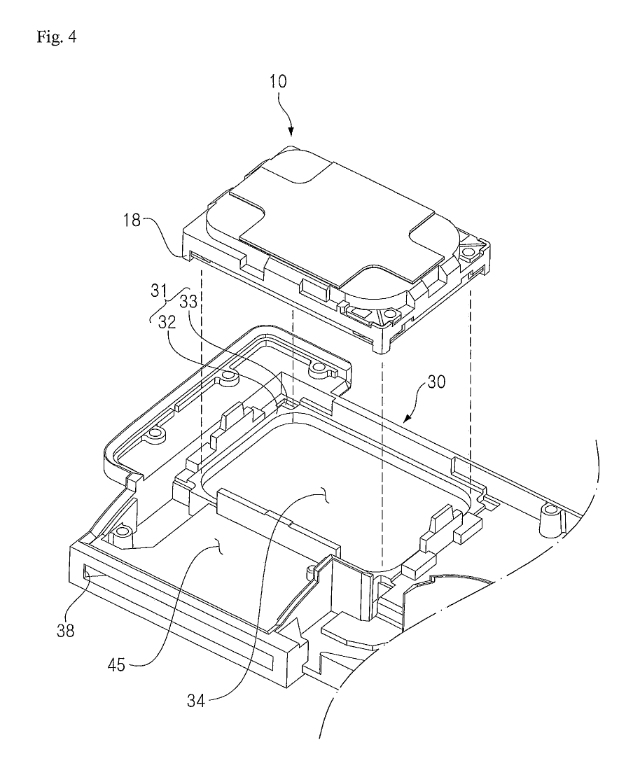

The supporting portion 31 includes a first supporting portion and a second supporting portion. In the embodiment of the present invention, the supporting portion 31 may include at least one of the first and second supporting portions. The first supporting portion includes a supporting rib 32, which is attached to an outer edge of the micro speaker 10 using an adhesive so as to support the micro speaker 10. The second supporting portion includes supporting recesses 33, into which supporting protrusions 18 respectively formed at corner regions of the micro speaker are inserted. Here, although the second supporting portion may be employed, to realize easiest supporting of the micro speaker 10, in a configuration in which the first supporting portion cannot be provided, it is desirable that both the first and second supporting portions be provided (see FIG. 4).

That is, in the present invention, to support the micro speaker 10, the supporting rib 32 may be adhesively attached to and supported by the outer edge of the micro speaker 10, or the supporting protrusions 18 formed at the corner regions of the micro speaker 10 may be inserted into the supporting recesses 33. Alternatively, the supporting rib 32 may be adhesively attached to and supported by the outer edge of the micron speaker 10, and simultaneously the supporting protrusions 18 may be inserted into the supporting recesses 33.

As such, the supporting portion 31 of the present invention is capable of efficiently supporting the micro speaker 10 with a minimum area thereof without the risk of a reduction in the volume of sound emitted from the micro speaker 10.

The first frame 30 further has a sound discharge duct 35, through which forward sound emitted from the micro speaker 10 that is supported by the supporting portion 31 is discharged outward from the micro speaker module.

The sound discharge duct 35, as illustrated, includes a first sound discharge duct 36 defined below the micro speaker 10 that is supported by the supporting portion 31, and a second sound discharge duct 37 that is in communication with the first sound discharge duct 36 to guide forward sound of the micro speaker 10 to one side surface of the first frame 30.

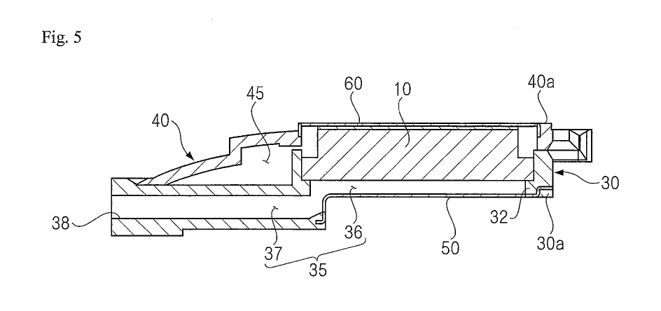

In this case, a sound discharge hole 38 formed at a distal end of the second sound discharge duct 37 is located at one side surface of the first frame 30, differently from the related art in which a sound discharge hole is perforated in one surface of the first frame (for example, a lower surface 30a of the first frame 30 in FIG. 5).

With the above described configuration, in the case of the first frame 30 according to the present invention, it is unnecessary to provide the surface 30a of the first frame 30 with a predetermined thickness required for provision of the sound discharge hole 38. As such, the surface 30a of the first frame 30 may have a reduced thickness.

Although not illustrated in detail in the drawings, a duct cover may be provided to cover an upper side of the second sound discharge duct 37. The duct cover (not shown) serves to separate the second sound discharge duct 37 from a back volume space 45 that will be described hereinafter. The duct cover may be formed of a stainless steel material, a film member material, or a PORON material, for example. The duct cover for covering the upper side of the second sound discharge duct 37 may be employed in the case in which a space for the sound discharge duct is insufficient or a mold structure thereof is not permitted upon injection molding of the first frame 30.

Additionally, the first frame 30 has a first through-hole 34 into which the micro speaker 10 is fitted. The first through-hole 34 is perforated in an uppermost protruding portion of the surface 30a of the first frame 30. A first cover 50 is integrally formed with the first frame 30 by insert injection molding to cover a predetermined area including the first through-hole 34. The first cover 50 contributes to a reduction in the thickness of the surface 30a of the first frame 30. That is, the first cover 50 is positioned on and around an area corresponding to the micro speaker 10, thereby covering at least the predetermined area including the first through-hole 34 as described above.

The first cover 50, which is insert-injection molded with the first frame 30, is formed of a stainless steel material and has a less thickness than that of the first frame 30. However, as occasion demands, insert injection molding of the first cover 50 may be impossible because of a mold structure thereof is not permitted upon injection molding of the first frame 30. In this case, the first cover 50 may be formed of a thin film member material or PORON material, and may be attached to the surface of the first frame 30 using an adhesive. Here, the film member material may be a synthetic resin material, such as polyethylene terephthalate (PET).

As described above, according to the present invention, as a result of positioning the sound discharge hole 38 at one side surface of the first frame 30 and of insert injection molding or attaching the thin first cover 50 with or to a specific portion of the first frame 30 where the micro speaker 10 is installed, the first frame 30 of the present invention may have a reduced thickness.

In the present invention, moreover, the outer edge of the micro speaker 10 is supported by the supporting rib 32 under assistance of the adhesive as described above. In this way, the first frame 10 of the present invention eliminates a need for a gasket used to support the micro speaker 10, and can achieve a reduction in thickness corresponding to the thickness of the gasket.

The second frame 40, as described above, is coupled to the first frame 30 to cover the open side of the first frame 30 by which the micro speaker 10 is supported. The second frame 40 and the first frame 30 define the back volume space 45 therebetween, to prevent rearward sound emitted from the micro speaker 10 that is supported by the supporting portion 31 of the first frame 30 from being mixed with forward sound and undergoing destructive interference.

The back volume space 45, as illustrated, is preferably defined as a separate space located at a lateral side of the micro speaker 10 rather than a space for supporting the micro speaker 10. The back volume space 45 is in communication with a space defined at the rear side of the micro speaker 10, thereby blocking rearward sound emitted from the micro speaker 10.

One surface of the second frame 40 (i.e. an upper surface 40a of the second frame 40 in FIG. 5) is provided with a second through-hole 44 corresponding to the first through-hole 34 of the first frame 30. Accordingly, the second frame 40 is provided with a second cover 60 to cover at least the second through-hole 44. Providing the second cover 60 contributes to a reduction in the thickness of the surface 40a of the second frame 40.

In this case, similar to the first cover 50, the second cover 60 is formed of a stainless steel material and has a less thickness than that of the second frame 40 that is formed of a synthetic resin. As occasion demands, however, insert injection molding of the second cover 60 may be impossible because a mold structure is not permitted upon injection molding of the second frame 40. In this case, the second cover 60 may be formed of a thin film member material or PORON material, and may be attached to one surface of the second frame 40 using an adhesive.

Accordingly, according to the present invention, as a result of insert injection molding or attaching the second cover 60 with or to a specific portion of the second frame 40 where the micro speaker 10 is installed, the second frame 40 may have a reduced thickness.

As is apparent from the above description, according to the present invention, in a micro speaker module consisting of a micro speaker and an enclosure, through-holes are perforated in corresponding portions of first and second frames of the enclosure where the micro speaker is supported, and covers provided to close the respective through-holes are prepared by insert injection molding, which can result in a reduction in the thickness of one surface of each frame.

Further, according to the present invention, as a result of positioning a sound discharge hole at one side surface of the enclosure, it is unnecessary to provide one surface of the first frame with more than a predetermined thickness required for formation of the sound discharge hole, which can result in a reduction in the thickness of the first frame.

Further, according to the present invention, an outer edge of the micro speaker is adhesively attached to a supporting rib of the first frame without requiring a gasket, which can also contribute to a reduction in the thickness of the first frame.

Furthermore, according to the present invention, the micro speaker is supported by a supporting portion of the first frame including a supporting rib and supporting recesses. The supporting portion, more particularly, the supporting rib, can not only to efficiently support the micro speaker with a minimum area thereof, but also to prevent a reduction in the volume of sound emitted from the micro speaker.

Although the exemplary embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A micro speaker module comprising a micro speaker and an enclosure configured to support the micro speaker,
wherein the enclosure includes a first frame having a supporting portion configured to support the micro speaker, and a second frame configured to cover an open side of the first frame by which the micro speaker is supported, and
wherein a first cover and a second cover are respectively insert injection molded with or attached to portions of the first frame and the second frame corresponding to the micro speaker that is supported by the supporting portion.

2. The micro speaker module according to claim 1,
wherein first and second through-holes are respectively formed in surfaces of the first and second frames corresponding to front and rear surfaces of the micro speaker that is supported by the supporting portion, and
wherein the first and second covers are insert injection molded or attached to cover at least the first and second through-holes respectively.

3. The micro speaker module according to claim 2, wherein the first and second covers are formed of any one of a stainless steel material, a film member material, and a PORON material.

4. The micro speaker module according to claim 1,
wherein the first frame includes a sound discharge duct, through which forward sound emitted from the micro speaker that is supported by the supporting portion is discharged outward, and
wherein the sound discharge duct includes a first sound discharge duct defined in front of the micro speaker that is supported by the supporting portion, and a second sound discharge duct in communication with the first sound discharge duct to guide the forward sound emitted from the micro speaker to one side surface of the first frame.

5. The micro speaker module according to claim 1, wherein the supporting portion, which is provided at the first frame to support the micro speaker, includes at least one of a supporting rib configured to support an outer edge of the micro speaker and a supporting recess into which a supporting protrusion formed at a corner region of the micro speaker is inserted.

6. The micro speaker module according to claim 1,
wherein a back volume space is defined between the first frame and the second frame, and blocks rearward sound emitted from the micro speaker that is supported by the supporting portion, so as to prevent the rearward sound from mixing with the forward sound, and
wherein the back volume space is located at a lateral side of a space in which the micro speaker is installed.
